(19) United States
(12) Patent Application Publication
(10) Pub. No.: US 2013/0177766 A1
(43) Pub. Date: Jul. 11, 2013

(54) APPARATUS FOR LAYER-BY-LAYER PRODUCTION OF THREE-DIMENSIONAL OBJECTS BY ROTATING APPLICATION

(71) Applicants: Maik GREBE, Bochum (DE); Wolfgang DIEKMANN, Waltrop (DE); Sigrid HESSEL-GELDMANN, Haltern am See (DE)

(72) Inventors: Maik GREBE, Bochum (DE); Wolfgang DIEKMANN, Waltrop (DE); Sigrid HESSEL-GELDMANN, Haltern am See (DE)

(21) Appl. No.: 13/722,159

(22) Filed: Dec. 20, 2012

(30) Foreign Application Priority Data
Jan. 6, 2012 (DE) 10 2012 200 160.3

(51) Int. Cl. B29C 67/00; B32B 5/00

(52) U.S. Cl. CPC B29C 67/0077; B32B 5/00
USPC 428/411.1; 425/174.4; 264/460

(57) ABSTRACT

The present invention relates to an apparatus for the layer-by-layer production of three-dimensional objects, to processes for layer-by-layer production, and also to corresponding shaped articles.

### FIELD OF THE INVENTION

The present invention relates to an apparatus for the layer-by-layer production of three-dimensional objects, to processes for layer-by-layer production, and also to corresponding shaped articles.

### DISCUSSION OF THE BACKGROUND

The rapid provision of prototypes is a task frequently encountered in very recent times. Processes which permit this are termed rapid prototyping/rapid manufacturing, or else additive fabrication processes. Particularly suitable processes use operations based on pulverulent materials, where the desired structures are produced layer by layer, by selective melting and solidifying. Supportive structures for overhangs and undercuts are not needed here, since the plane of the construction field that surrounds the melted regions provides sufficient support. The subsequent operation of removing supports is likewise omitted. The processes are also suitable for producing short runs. The temperature of the construction chamber is selected such that no warpage of the structures produced layer by layer occurs during the construction procedure.

One process which is especially suitable for the purposes of rapid prototyping is selective laser sintering (SLS). In this process, plastics powders in a chamber are exposed briefly and selectively to a laser beam, and this causes melting of the powder particles impacted by the laser beam. The melted particles coalesce and rapidly resolidify to give a solid mass. Three-dimensional bodies can be produced simply and rapidly by this process, by repeatedly exposing a constant succession of freshly applied layers to light.

The laser sintering (rapid prototyping) process for producing shaped articles from pulverulent polymers is described in detail in U.S. Pat. No. 6,136,948 and WO 96/06881 (both DTM Corporation). A wide variety of polymers and copolymers is claimed for this application, such as polyacetate, polypropylene, polyethylene, ionomers and polyamide, for example.

Other highly suitable processes are the SIB process (selective inhibition of bonding) as described in WO 01/38061, or a process as described in EP 1015214. Both processes operate with extensive infrared heating to melt the powder. The selectivity of the melting operation is achieved in the first case by the application of an inhibitor and in the second process by a mask. DE 10311438 describes a further process. In this case, the energy needed for melting is introduced by a microwave generator, and the selectivity is achieved by application of a susceptor. A further process is described in WO 2005/105412, where the energy needed for melting is introduced by means of electromagnetic radiation, and, likewise, the selectivity is again achieved by application of an absorber.

A problem with the processes known from the art is that the powders used must be flowable, in order to allow flawless layer application. Only if layer application is flawless is it possible to produce three-dimensional objects of high quality. If flowability is inadequate, regions of the construction field are coated inadequately, or not at all, with powder. Moreover, channels, waves or fissures may appear in the powder of the plane of the construction field. In processing, this leads to problems, and so at the end of the process the three-dimensional objects produced exhibit defects. Powder application using a rotating roller in particular is problematic since, in the case of powders which are not flowable, they adhere to the roller and hinder powder application.

Thus, the flowability of the powders employed can be improved by addition of additives, as described in EP 1443073, for example. A disadvantage of this procedure is that the additives are then also part of the three-dimensional objects produced, and in certain applications this may be undesirable for these objects. Moreover, adding additives to raise the flowability usually also has the effect of increasing warpage in the three-dimensional objects produced. Even with the addition of additives, furthermore, very fine powders cannot be made flowable or can be given only limited flowability.

It is an object of the present invention, therefore, to produce a new apparatus which no longer has the disadvantages of the prior art. This should make it possible to improve the application of low-flowability powders in the production of three-dimensional objects.

### SUMMARY OF THE INVENTION

The stated object is achieved by apparatus according to the present invention. A first subject of the present invention is an apparatus for the layer-by-layer production of three-dimensional objects (moulds), comprising a construction chamber (10) with an adjustable-height construction platform (6), with an application apparatus (7) for applying, to the construction platform (6), a layer of a material solidifiable by exposure to electromagnetic radiation, and with irradiation equipment comprising a radiation source (1) which emits electromagnetic radiation, a control unit (3) and a lens (8) which is located in the beam path of the electromagnetic radiation, for irradiating points of the layer corresponding to the object (5), said application apparatus (7) for applying a layer being designed in the form of a rotating cylinder whose outer surface has a roughness Rz according to DIN EN ISO 4287:1998 of at least 100 μm.

Another subject of the present invention is an apparatus for the layer-by-layer production of three-dimensional objects (moulds) comprising a construction chamber (10) with an adjustable-height construction platform (6), with an application apparatus (7′) for applying, to the construction platform (6), a layer of a material solidifiable by exposure to electromagnetic radiation, and with irradiation equipment comprising a radiation source (1) which emits electromagnetic radiation, a control unit (3) and a lens (8) which is located in the beam path of the electromagnetic radiation, for irradiating points of the layer corresponding to the object (5), the application apparatus (7′) for applying a layer being designed in the form of a rotating cylinder which is provided with a brush trim (15). This produces a kind of circular brush. The brush trim (15) is preferably selected from the group of natural fibres, synthetic fibres, artificial bristles, which may have been interspersed with abrasives, or of metal wires, and also mixtures thereof, preference being given to metal wires.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 shows the principles of construction of an apparatus for producing three-dimensional objects in accordance with the present invention;

FIG. 2 shows a non-inventive application apparatus;

FIG. 3 shows an inventive application apparatus (7);

FIG. 4 shows a further inventive application apparatus; and

FIG. 5 shows a further inventive configuration of the apparatus.

### DETAILED DESCRIPTION OF THE PREFERRED EMBODIMENTS

The two articles comprising the application apparatuses (7) and (7′) (rough surface and brush trim) can be combined with one another.

For application in a layer process, powders having a flow time of more than 35 s or classed as non-flowable (measured in accordance with DIN EN ISO 6186, method A, flow diameter 15 mm) were hitherto regarded as being impossible to apply. With the present invention it is now possible to process powders of these kinds.

The rotating cylinder (roll) as application apparatus (7) or (7′) therefore serves to distribute the powder and to apply one further layer of the powder. In this case, application takes place not by sliding (as in the case of a doctor blade or broom), but instead by rotation of the cylinder. Application preferably takes place only by means of the rotating cylinder, and not by means of a further roll, an additional doctor blade, or the like. There is therefore no need to smooth the powder layer, using a further application apparatus, after it has been applied by the cylinder. It is therefore preferred for the apparatus to include no further application apparatus. A system of this kind is referred to by the skilled person as “single-piece”.

The doctor blade is disadvantageous in so far as poorly pourable or flowable powders may adhere to the doctor blade.

In principle, the metal cylinder may rotate in the direction of application or counter to the direction of application, with preference being given to application counter to the direction of application.

The “corresponding points” of the object each represent a layer of the sliced contour of the object, which is melted or sintered into the powder bed in steps by the driving of the laser beam.

It has surprisingly emerged that with apparatuses in accordance with the present invention it is possible to apply even low-pourability or low-flowability powders, thereby making it possible to reduce the addition of additives or to do without them entirely. It is especially surprising here that the stated object can be achieved using an application apparatus (7) and/or an application apparatus (7′) which is configured in the form of a rotating cylinder, the outer surface of the cylinder having a roughness Rz of at least 100 μm (DIN EN ISO 4287:1998, determined by the stylus method in accordance with DIN EN ISO 3274, Hommel Tester T1000 Wave from Jenoptik, tip radius 5 μm, conical angle 90°) or the cylinder being provided with a brush trimming (15).

The roughness Rz of the outer surface is preferably at least 175 μm. More preferably the roughness Rz of the outer surface is at least 250 μm, most preferably from 250 μm to 500 μm.

The cylinder and its surface may be made, for example, from plastics or metals. The outer surface of the cylinder is preferably composed of, or comprises, metal or a metal alloy.

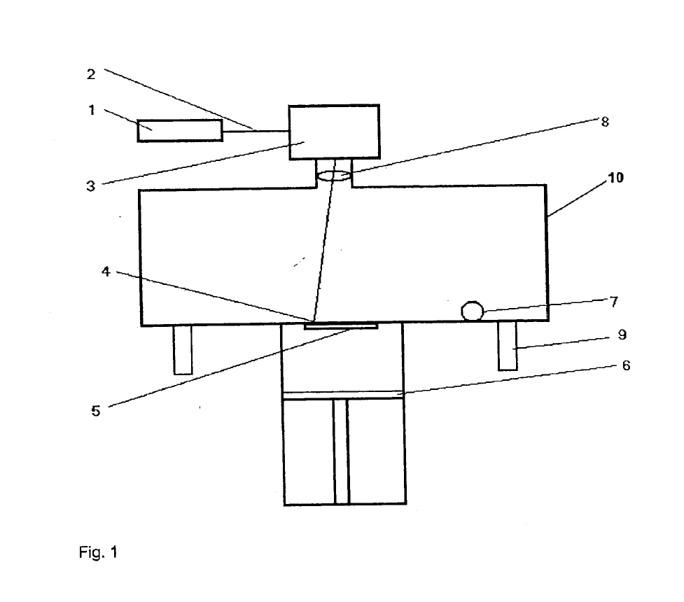

FIG. 1 shows the principles of construction of an apparatus for producing three-dimensional objects in accordance with the present invention. The component is positioned centrally in the construction field. The laser beam (2) from a laser (1) is deflected by means of a scanning system (3) through the lens (8) onto a temperature-controlled and inertized—preferably nitrogen-inertized—powder surface (4) of the object (5) to be formed. The lens here has the function of separating the remaining optical components, such as the mirrors of the scanner, for example, from the atmosphere of the construction chamber. The lens is often configured as an F-theta lens system, in order to ensure maximum homogeneity of focus over the entire working field. Located within the construction chamber is the apparatus (7) for applying the material to be solidified to the construction platform (6), the application apparatus being designed in the form of a rotating cylinder whose outer surface has a roughness Rz according to DIN EN ISO 4287:1998 of at least 100 μm.

It is further preferred for the apparatus to have a heating element for the temperature control of the construction chamber. By this means the construction chamber can be brought, for example, to the ideal temperature (processing temperature) for producing the three-dimensional object.

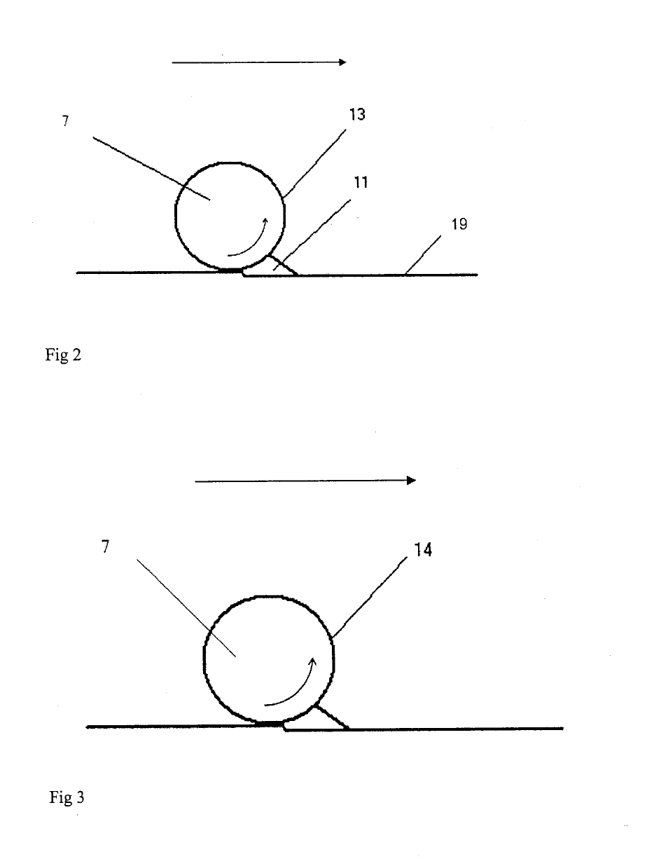

FIG. 2 shows a non-inventive application apparatus. The application apparatus (7) is configured in the form of a metal cylinder which rotates contrary to the direction of application and applies the powder (11) to the plane (19) of the construction field. The roughness Rz (maximum height of the profile) according to DIN EN ISO 4287:1998 determined by the stylus method according to DIN EN ISO 3274 (Hommel Tester T1000 Wave from Jenoptik, tip radius 5 μm, conical angle 90°) of the outer face (13) is 64 μm.

FIG. 3 shows an inventive application apparatus (7). Here again, the application apparatus (7) is configured in the form of a metal cylinder which rotates, during powder application, contrary to the direction of application. The roughness Rz according to DIN EN ISO 4287:1998 of the outer face (14) here is 183 μm.

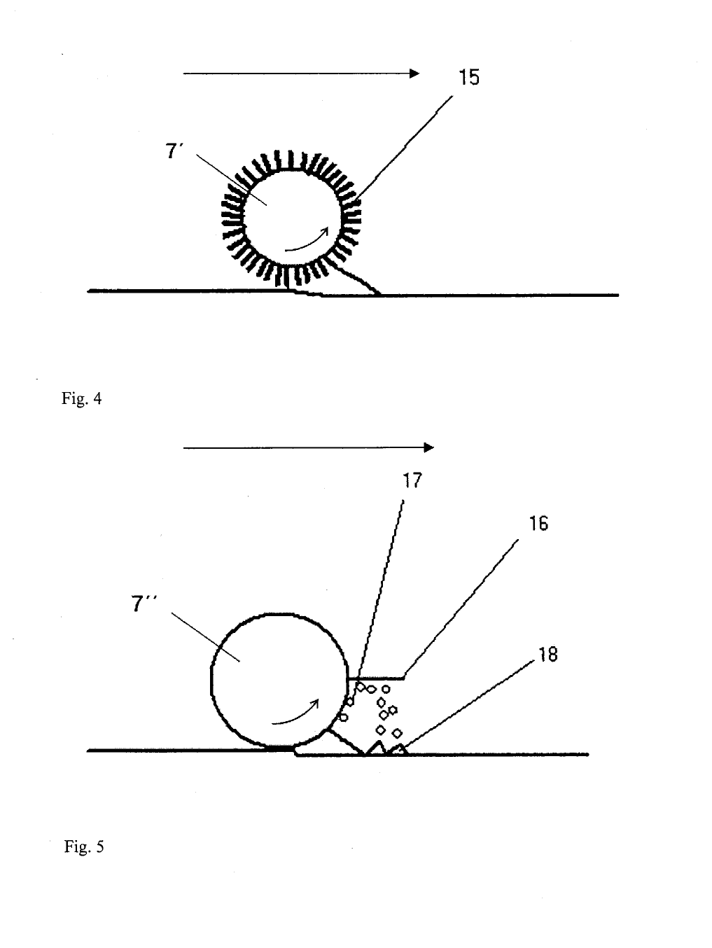

FIG. 4 shows a further inventive application apparatus. Here again, the application apparatus (7′) is configured in the form of a metal cylinder which rotates, during powder application, contrary to the direction of application. The outer face here is equipped with metal wires of equal length as the brush trimming (15). In principle, the brush trimming can be of a different length, but it is preferable for it to be of equal length.

In one preferred embodiment, the fibres, bristles and wires of the brush trim (15), in each case independently of one another, have a diameter of 0.2 mm to 3 mm, a (trim) length of 0.25 mm to 75 mm, and a trim density of 5/cm² to 1000/cm². With particular preference the trim density is at least 10/cm².

The fibres, bristles and wires are preferably applied perpendicularly to the axis of rotation of the cylinder. The fibres, bristles and wires preferably stand perpendicularly on the outer surface of the cylinder.

FIG. 5 shows a further inventive configuration of the apparatus. Here again, the application apparatus (7″) is configured in the form of a metal cylinder which rotates, during powder application, contrary to the direction of application. Powder (17) adhering to the metal cylinder is removed from the outer face of the cylinder by means of a stripper (16), more particularly in such a way that the powder in loosened form falls ahead of the cylinder (18). The stripper is preferably aligned in rotational symmetry with respect to the cylinder. The stripper may be configured in brush form or else as a thin plate, with appropriate materials for the stripper being metals which are less hard than the metal of the cylinder. However, other materials as well are conceivable for the stripper, provided that they have an appropriate temperature resistance.

In accordance with the invention, the stripper (16) may be combined with an application apparatus (7) or an application apparatus (7′).

Likewise a subject of the present invention are processes for the layer-by-layer production of three-dimensional objects, that are carried out in one of the apparatuses according to the invention.

Processes which can produce shaped parts according to the invention from powder are described below, but without any intention that the invention be confined to this description.

In principle, any of the polymer powders known to the person skilled in the art is suitable for use in the apparatus of the invention or in the process of the invention. Thermoplastic and thermoelastic materials are particularly suitable, for example polyethylene (PE, HDPE, LDPE), polypropylene (PP), polyamides, polyesters, polyester esters, polyether esters, polyphenylene ethers, polyacetals, polyalkylene terephthalates, in particular polyethylene terephthalate (PET) and polybutylene terephthalate (PBT), polymethyl methacrylate (PMMA), polyvinyl acetal, polyvinyl chloride (PVC), polyphenylene oxide (PPO), polyoxymethylene (POM), polystyrene (PS), acrylonitrile-butadiene-styrene (ABS), polycarbonates (PC), polyether sulphones, thermoplastic polyurethanes (TPU), polyaryletherketones, in particular polyetheretherketone (PEEK), polyetherketoneketone (PEKK), polyetherketone (PEK), polyetheretherketone-ketone (PEEKK), polyaryletheretheretherketone (PEEEK) or polyetherketoneetherketoneketone (PEKEKK), polyetherimides (PEI), polyarylene sulphides, in particular polyphenylene sulphide (PPS), thermoplastic polyimides (PI), polyamideimides (PAI), polyvinylidene fluorides, and also copolymers of the said thermoplastics, such as a polyaryletherketone (PAEK)/polyarylether sulphone (PAES) copolymer, mixtures and/or polymer blends. With special preference, the polymer powder comprises at least one polyamide such as PA6, PA66, PA610, PA613, PA1010, PA106, PA11, PA12, PA1012, pA1013 or mixtures thereof or polyetherketones, preferably PEEK. Polyamides, in particular polyamide 12, polyamide 6 or polyamide 6,6, are most particularly preferred.

In addition, metal powders comprising, for example, iron, titanium or aluminium, or consisting thereof, or ceramic powders are also suitable. Polymer powders are preferably used.

The grain size of the powder is not particularly limited and may preferably have a d₅₀ of <60 μm, more preferably <50 μm, even more preferably <40 μm and even more preferably <30 μm.

In operation, an engineering program or the like is generally first used to generate or store, in a computer, data concerning the shape of the object (5) to be produced. For the production of the object, the said data are processed in such a way that the object is dissected into a large number of horizontal layers which are thin in comparison with the size of the object, and the shape data are provided for each of this large number of layers, for example in the form of data sets, e.g. CAD data. The generation and processing of the data for each layer here can take place prior to the production process or else simultaneously with the production of each layer.

The construction platform (6) is then first moved by means of the height-adjustment apparatus to the highest position, in which the surface of the construction platform (6) is in the same plane as the surface of the construction chamber, and is then lowered by an amount corresponding to the intended layer thickness of the first layer of material in such a way that, within the resultant aperture, a lowered region has been formed, delimited laterally by the walls of the aperture and below by the surface of the construction platform (6). A first layer of the material to be solidified, with the intended layer thickness, is then introduced by means of the application apparatus (7) or the application apparatus (7′) in the form of a rotating cylinder into the cavity formed by the aperture and the construction platform (6), or into the lowered region, and is optionally heated by a heating system to a suitable operating temperature, for example 100° C. to 360° C., preferably 120° C. to 200° C. The control unit (3) then controls the deflector device in such a way that the deflected light beam (2) successively impacts all points of the layer, and sinters or melts the material there. A solid basal layer can thus first be formed. In a second step, the construction platform (6) is lowered by means of the height-adjustment apparatus by an amount corresponding to one layer thickness, and a second layer of material is introduced by means of the application apparatus (7) or (7′) into the resultant lowered region within the aperture, and optionally in turn heated by the heating system.

In one embodiment, the control unit (3) can on this occasion control the deflector device in such a way that the deflected light beam (2) impacts only that region of the layer of material that is adjacent to the inner surface of the aperture, and solidifies the layer of material there by sintering, thus producing a first annular wall layer with a wall thickness of about 2 to 10 mm which completely surrounds the remaining pulverulent material of the layer. This part of the control system is therefore a device for producing a container wall which surrounds the object (5) to be formed, simultaneously with the formation of the object in each layer.

Once the construction platform (6) has been lowered by an amount corresponding to the layer thickness of the next layer, and the material has been applied and heated in the same manner as above, the production of the object (5) itself can now begin. For this, the control unit (3) controls the deflector device in such a way that the deflected light beam (2) impacts those points of the layer which, according to the coordinates stored in the control unit for the object (5) to be produced, are intended to be hardened. The procedure for the other layers is analogous. In the case of the desired production of an annular wall region in the form of a container wall which encloses the object together with the remaining, unsintered material and thus inhibits escape of the material when the construction platform (6) is lowered below the work table, the device is used to sinter an annular wall layer onto the annular wall layer located thereunder for each layer of the object. Production of the wall can be omitted if a replaceable vessel according to EP 1037739, or a fixedly installed container, is used.

After cooling, the object formed can be removed from the apparatus.

The subject of the present invention are likewise the objects produced by the processes of the invention.

It is assumed that a person skilled in the art can use the above description to its fullest extent even in the absence of any further information. The preferred embodiments and examples are therefore to be interpreted merely as descriptive disclosure, and certainly not as in any way limiting disclosure.

Examples are used below for further explanation of the present invention. Alternative embodiments of the present invention are obtainable analogously.

Having generally described this invention, a further understanding can be obtained by reference to certain specific examples which are provided herein for purposes of illustration only and are not intended to be limiting unless otherwise specified.

### EXAMPLES

The examples are operated in accordance with the description below unless indicated otherwise. The construction chamber is heated for up to 120 min to the process temperature. The temperature in the construction chamber is then increased to the process temperature. The temperature distribution in the construction chamber is not always homogeneous, and the temperature measured by means of a pyrometer is therefore defined as construction-chamber/process temperature. Prior to the first exposure to light, 40 layers of powder are applied. The laser beam (2) from the laser (1) is deflected by means of a scanning system (3) through the lens (8) onto the temperature-controlled and inertized (N₂) plane (4) of the construction field. The lens is configured as an F-theta lens system, in order to ensure an extremely homogeneous focus over the entire construction-field plane.

The component to be exposed to light is positioned centrally in the construction field. A square area with edge length 50 mm is melted by means of the laser. The construction platform (6) is then lowered by 0.1 mm, and a layer of powder is applied at a velocity of 250 mm/s by means of an application apparatus (7) or (7′). The said steps are repeated until a three-dimensional component (5) of height 50 mm is produced. After the exposure to light has been concluded, 40 further layers are applied before the heating elements are switched off and the cooling phase is initiated. The time needed for each layer during the entire construction process is below 40 seconds.

After a cooling time of at least 12 hours, the component is removed and freed from the adhering powder.

### Example 1 (not According to the Invention)

The construction process is carried out in an SPro60 HDHS from 3d-Systems, USA. A PA12 powder with the powder properties in Table 1 is processed. The powder is applied with the apparatus of the SPro60 HDHS. The roughness Rz according to DIN EN ISO 4287:1998 of the outer surface of the cylinder is 64 μm made of steel C60. The process temperature is 169° C. The temperature in the powder reservoir is in each case 129° C. The exposure parameters are as follows: laser power 54.0 W, scan velocity 12000 mm/s, distance between exposure lines 0.3 mm. The quality of the applied powder layers is poor. Powder still adheres to the outer surface of the cylinder. Channels are visible in the construction field. At certain points in the plane of the construction field, too little powder is applied, or none. The three-dimensional object produced has severe surface defects.

### Example 2 (According to the Invention)

The trial is carried out in the construction chamber of an SPro60 HDHS from 3d-Systems. A PA12 powder with the powder properties in Table 1 is processed. The process temperature is 169° C. The temperature in the powder reservoir is in each case 129° C. The exposure parameters are as follows: laser path 54.0 W, scan velocity 12000 mm/s, distance between exposure lines 0.3 mm. The powder is applied using a metal cylinder (7) whose outer surface (steel C60) has an Rz according to DIN EN ISO 4287:1998 of 183 μm. The powder is readily applied. Only a small amount of powder still adheres to the outer surface of the cylinder. The construction-field plane is coated completely. The three-dimensional object produced does not have any surface defects.

### Example 3 (According to the Invention)

The trial is carried out in the construction chamber of an SPro60 HDHS from 3d-Systems. A PA12 powder with the powder properties in Table 1 is processed. The process temperature is 169° C. The temperature in the powder reservoir is in each case 129° C. The exposure parameters are as follows: laser path 54.0 W, scan velocity 12000 mm/s, distance between exposure lines 0.3 mm. The powder is applied using a metal cylinder (7′) which is used with wire bristles (metal wire) made of brass (diameter 1 mm, length 10 mm, 60 wires/cm²). The powder is readily applied. The construction-field plane is coated completely. The three-dimensional object produced does not have any surface defects.

### Example 4 (According to the Invention)

The trial is carried out in the construction chamber of an SPro60 HDHS from 3d-Systems. A PA12 powder with the powder properties in Table 1 is processed. The process temperature is 169° C. The temperature in the powder reservoir is in each case 129° C. The exposure parameters are as follows: laser path 54.0 W, scan velocity 12000 mm/s, distance between exposure lines 0.3 mm. The powder is applied using a metal cylinder (7) whose outer face (steel C60) has an Rz according to DIN EN ISO 4287:1998 of 104 μm. The stripper (7″) is mounted at the height of the axis of rotation of the metal cylinder, and parallel to the plane of the construction field. A small amount of powder remains adhering to the outer face of the cylinder, but is removed again from the outer face by the stripper, and is scattered ahead of the metal cylinder. The powder is readily applied. The construction-field plane is coated completely. The three-dimensional object produced does not have any surface defects.

TABLE 1
Key powder data

| | Value | Unit | Test type/Test equipment/Test parameters |
|---|---|---|---|
| Polymer | Polyamide 12 | | |
| Bulk density | 0.355 | g/cm³ | DIN EN ISO 60 |
| Grain size d50 | 18 | μm | Malvern Mastersizer 2000, dry measurement, |
| | | | 20-40 g of powder added by means of Scirocco |
| | | | dry dispersion equipment. |
| | | | Feed rate vibratory trough 70%, dispersion air |
| | | | pressure 3 bar. Specimen measurement time |
| | | | 5 seconds (5000 individual measurements), |
| | | | refractive index and blue-light value defined as |
| | | | 1.52. |
| | | | Evaluation by way of Mie theory |
| Grain size d10 | 11 | μm | Malvern Mastersizer 2000, parameters: see grain |
| | | | size d50 |
| Grain size d90 | 38 | μm | Malvern Mastersizer 2000, parameters: see grain |
| | | | size d50 |
| <10.48 μm | 9 | % | Malvern Mastersizer 2000, parameters: see grain |
| | | | size d50 |
| Flowability | Does not flow under | s | DIN EN ISO 6186, Method A, nozzle outlet |
| | test conditions | | diameter 15 mm |
| Solution viscosity | 1.53 | — | ISO 307, Schott AVS Pro, solvent acidic m- |
| | | | cresol, volumetric method, two measurements, |
| | | | dissolution temperature 100° C., dissolution time |
| | | | 2 h, polymer concentration 5 g/l, measurement |
| | | | temperature 25° C. |
| BET (spec. surface area) | 10.2 | m²/g | ISO 9277, Micromeritics TriStar 3000, nitrogen |
| | | | gas adsorption, discontinuous volumetric |
| | | | method, 7 measurement points at relative |
| | | | pressures P/P0 from about 0.05 to about 0.20, |
| | | | dead volume calibration by means of |
| | | | He (99.996%), specimen preparation 1 h at 23° C. + |
| | | | 16 h at 80° C. in vacuo, spec. surface area based |
| | | | on devolatilized specimen, evaluation by means |
| | | | of multipoint determination |
| Melting point, 1^{st} heating | 182 | ° C. | DIN 53765 DSC 7 v. Perkin Elmer, |
| procedure | | | heating/cooling rate 20 K/min |
| Recrystallization temperature | 139 | ° C. | DIN 53765 DSC 7 v. Perkin Elmer, |
| | | | heating/cooling rate 20 K/min |

| | |
|---|---|
| Conditioning of the material | Material is stored for 24 h at 23° C. and 50% |
| | humidity prior to processing/analysis |

Obviously, numerous modifications and variations of the present invention are possible in light of the above teachings. It is therefore to be understood that within the scope of the appended claims, the invention may be practiced otherwise than as specifically described herein.

This application is based on German patent application DE 10 2012 200 160.3 filed in the German Patent Office on Jan. 6, 2012, the entire contents of which are hereby incorporated by reference.

What is claimed as new and desired to be secured by Letters Patent of the United States is:

1. An apparatus for the layer-by-layer production of three-dimensional objects, comprising a construction chamber (10) with an adjustable-height construction platform (6), with an apparatus (7) for applying, to the construction platform (6), a layer of a material solidifiable by exposure to electromagnetic radiation, and with irradiation equipment comprising a radiation source (1) which emits electromagnetic radiation, a control unit (3) and a lens (8) which is located in the beam path of the electromagnetic radiation, for irradiating points of the layer corresponding to the object (5), wherein the apparatus (7) for applying a layer is designed in the form of a rotating cylinder whose outer surface has a roughness Rz according to DIN EN ISO 4287:1998 of at least 100 μm.

2. The apparatus according to claim 1, wherein said apparatus does not comprise a further application apparatus.

3. The apparatus according to either of the preceding claims, wherein said roughness is at least 175 μm.

4. An apparatus for the layer-by-layer production of three-dimensional objects, comprising a construction chamber (10) with an adjustable-height construction platform (6), with an apparatus (7′) for applying, to the construction platform (6), a layer of a material solidifiable by exposure to electromagnetic radiation, and with irradiation equipment comprising a radiation source (1) which emits electromagnetic radiation, a control unit (3) and a lens (8) which is located in the beam path of the electromagnetic radiation, for irradiating points of the layer corresponding to the object (5), wherein the apparatus (7′) for applying a layer is designed in the form of a rotating cylinder which is provided with a brush trim (15).

5. The apparatus according to claim 4, wherein said brush trim (15) is at least one selected from the group consisting of natural fibres, synthetic fibres, artificial bristles and metal wires.

6. The apparatus according to claim 5, wherein fibres, bristles or wires of said brush trim have a diameter of 0.2 to 3 mm.

7. The apparatus according to claim 5 or 6, wherein fibres, bristles or wires of said brush trim have a length of 0.25 mm to 75 mm.

8. The apparatus according to claim 5 or 6, wherein fibres, bristles or wires of said brush trim have a trim density of 5/cm² to 1000/cm².

9. The apparatus according to claim 1, wherein an outer surface of said rotating cylinder comprises a metal or a metal alloy.

10. The apparatus according to claim 1, wherein said rotating cylinder rotates counter to the direction of application.

11. The apparatus according to claim 1 or 4, further comprising a stripper (16).

12. A process for the layer-by-layer production of three-dimensional objects, the process being carried out in an apparatus comprising a construction chamber (10) with an adjustable-height construction platform (6), with an apparatus (7) for applying, to the construction platform (6), a layer of a material solidifiable by exposure to electromagnetic radiation, and with irradiation equipment comprising a radiation source (1) which emits electromagnetic radiation, a control unit (3) and a lens (8) which is located in the beam path of the electromagnetic radiation, for irradiating points of the layer corresponding to the object (5), where the apparatus (7) for applying a layer is designed in the form of a rotating cylinder whose outer surface has a roughness Rz according to DIN EN ISO 4287:1998 of at least 100 μm.

13. A process for the layer-by-layer production of three-dimensional objects, the process being carried out in an apparatus comprising a construction chamber (10) with an adjustable-height construction platform (6), with an apparatus (7′) for applying, to the construction platform (6), a layer of a material solidifiable by exposure to electromagnetic radiation, and with irradiation equipment comprising a radiation source (1) which emits electromagnetic radiation, a control unit (3) and a lens (8) which is located in the beam path of the electromagnetic radiation, for irradiating points of the layer corresponding to the object (5), where the apparatus (7′) for applying a layer is designed in the form of a rotating cylinder which is provided with a brush trim (15).

14. An object produced by a process according to either of claims 12 and 13.

15. A method for the layer-by-layer production of three-dimensional objects comprising sintering polymer powders having a flow time of more than 35 s or of non-flowable powders, measured with a flow diameter of 15 mm in accordance with DIN EN ISO 6186, method A.

16. The method according to claim 15, wherein said polymer powders are applied by a rotating cylinder whose outer surface has a roughness Rz according to DIN EN ISO 4287:1998 of at least 100 μm.

17. The method according to claim 15, wherein said polymer powders are applied by a rotating cylinder which is provided with a brush trim (15).

18. The apparatus according to claim 1, further comprising a polymer powder having a flow time of more than 35 s or of a non-flowable powder, measured with a flow diameter of 15 mm in accordance with DIN EN ISO 6186, method A.

19. The apparatus according to claim 4, further comprising a polymer powder having a flow time of more than 35 s or of a non-flowable powder, measured with a flow diameter of 15 mm in accordance with DIN EN ISO 6186, method A.
